(19) United States
(12) Patent Application Publication
(10) Pub. No.: US 2018/0052807 A1
(43) Pub. Date: Feb. 22, 2018

(54) ENDORSEMENT SMEARING AMONG RELATED WEBPAGES

(71) Applicant: Google Inc., Mountain View, CA (US)

(72) Inventors: Chuan JIANG, Sunnyvale, CA (US); Daniel Wesley Dulitz, Los Altos, CA (US); Eider Silva de Oliveira, Mountain View, CA (US); Evan Mallory Gilbert, Oakland, CA (US); Jeffrey Lawrence Korn, New York, NY (US); Davi de Castro Reis, Belo Horizonte (BR); Vinod Anupam, Cupertino, CA (US)

(73) Assignee: Google Inc., Mountain View, CA (US)

(21) Appl. No.: 14/080,721

(22) Filed: Nov. 14, 2013

Related U.S. Application Data
(60) Provisional application No. 61/726,531, filed on Nov. 14, 2012.

(51) Int. Cl. G06F 17/22

(52) U.S. Cl. CPC G06F 17/2247

(57) ABSTRACT

A system and method for combining endorsements in related webpages, the method including receiving an indication of an endorsement at a first webpage, incrementing a primary count of the first webpage in response to receiving the indication, determining if the first page is related to one or more other webpages, identifying the one or more other webpages related to the first page, if it is determined that the first page is related to one or more other webpages, incrementing a secondary count of the first webpage and the one or more other webpages if it is determined that the first page is related to one or more other webpages in response to receiving the indication and providing the secondary count for display at the one or more of the first webpage or the one or more other webpages.

### CROSS-REFERENCE TO RELATED APPLICATION

The present application claims the benefit of U.S. Provisional Patent Application Ser. No. 61/726,531, entitled “Endorsement Smearing Among Related Webpages,” filed on Nov. 14, 2012, which is hereby incorporated by reference in its entirety for all purposes.

### BACKGROUND

URL normalization (or URL canonicalization) is the process by which URLs are modified and standardized in a consistent manner. The goal of the normalization process is to transform a URL into a normalized or canonical URL so it is possible to determine if two syntactically different URLs may be equivalent (e.g., have the same canonical URL). Search engines employ URL normalization in order to assign importance to webpages and to reduce indexing of duplicate pages. Web crawlers perform URL normalization in order to avoid crawling the same resource more than once. Web browsers may perform normalization to determine if a link has been visited or to determine if a page has been cached. Thus, a canonical URL defines a base URL that a family of URLs may all resolve to. The association may be helpful in understanding the popularity or reach of a website with regards to social networking efforts.

### SUMMARY

The disclosed subject matter relates to a computer-implemented method for combining endorsements in related webpages, the method comprising receiving, at one or more computing devices, an indication of an endorsement at a first webpage, the first webpage being one of a webpage at a website or a profile or page at a social networking site. The method further comprising incrementing, using the one or more computing devices, a primary count corresponding to the first webpage in response to receiving the indication. The method further comprising determining, using the one or more computing devices, if the first page is related to one or more other webpages, wherein each of the one or more other webpages is a webpage at a website or a profile or page at a social networking site, wherein the website is external to the social networking site. The method further comprising identifying, using the one or more computing devices, the one or more other webpages being related to the first page, if it is determined that the first page is related to one or more other webpages. The method further comprising incrementing, using the one or more computing devices, a secondary count of the first webpage and the one or more other webpages if it is determined that the first page is related to one or more other webpages in response to receiving the indication and providing, using the one or more computing devices, the secondary count for display at the one or more of the first webpage or the one or more other webpages if it is determined that the first page is related to one or more other webpages.

The disclosed subject matter also relates to a computer-implemented method for combining endorsements in related webpages, the method comprising receiving, at one or more computing devices, an indication of an endorsement at a first webpage, the first webpage being one of a webpage at a website or a profile or page at a social networking site. The method further comprising incrementing, using the one or more computing devices, a primary count of the first webpage in response to receiving the indication. The method further comprising determining, using the one or more computing devices, if the first page is related to one or more other webpages, wherein each of the one or more other webpages is a webpage at a website or a profile or page at a social networking site. The method further comprising identifying, using the one or more computing devices, the one or more other webpages related to the first page, if it is determined that the first page is related to one or more other webpages and incrementing, using the one or more computing devices, a secondary count of the first webpage and the one or more other webpages if it is determined that the first page is related to one or more other webpages in response to receiving the indication.

The method further comprising providing, using the one or more computing devices, the secondary count for display at the one or more of the first webpage or the one or more other webpages if it is determined that the first page is related to one or more other webpages. The secondary count may be provided in response to a request to provide the endorsement count of one or more of the first webpage or the one or more other webpages. Each profile or page of the social networking site may be related to a webpage at a website, and wherein a webpage at a website is related to one or more other webpages at the website. The website may be remote and independent from the social networking site.

The method further includes receiving a request to associate the first webpage with an authority page of the one or more other webpages, wherein the first webpage is a profile or page at the social networking site and the authority page is a webpage at the website. The method further includes verifying that the first webpage and the authority page are related. The method further includes determining the primary count of the first webpage when it is determined that it is verified that the first webpage and the authority page are related to each other. The method further includes determining an endorsement count of the authority page. The method further includes generating a secondary count for the first webpage and the authority page, the secondary count comprising a sum of the primary count of the first webpage and the endorsement count of the authority page and assigning the secondary count of the first webpage, the authority page and the one or more other webpages related to the authority page.

The verifying that the first webpage and the authority page are related may comprise determining if a two way relationship exists between the first webpage and the authority page, wherein the two way relationship comprises identifying an relationship being indicated between the first webpage and the authority page at the website.

The endorsement count of the authority page may comprise the primary count of the authority page. The endorsement count of the authority page may comprise the sum of the primary count of the authority page and the one or more other webpages. The one or more other webpages may be identified as a canonical page of the authority page.

The method may further comprise storing, using the one or more computing devices, a record of the endorsement of the first webpage with respect to the first page and the one or more other pages, the record including information regarding the endorsement comprising the identity of the first page and the identity of the entity providing the endorsement.

The method may further comprise receiving a request to providing historical information regarding the endorsement of one or more of the first webpage or one or more other webpages, identifying one or more endorsements included within the secondary count of the first webpage and one or more other webpages, determining information regarding each of the one or more endorsements and providing the information for display in response to the request.

The disclosed subject matter also relates to a system for combining endorsements in related webpages, the system comprising one or more processors and a machine-readable medium comprising instructions stored therein, which when executed by the processors, cause the processors to perform operations comprising receiving a request to associate a first webpage with an authority page, wherein the first webpage is a profile or page at the social networking site and the authority page is a webpage at a website. The operations further comprising verifying that the first webpage and the authority page are related to one another. The operations further comprising determining the primary count of the first webpage when it is verified that the first webpage and the authority page are related to one another. The operations further comprising determining an endorsement count of the authority page. The operations further comprising generating a secondary count for the first webpage and the authority page, the secondary count comprising a sum of the primary count of the first webpage and the endorsement count of the authority page and assigning the secondary count with the first webpage and the authority page.

The verifying that the first webpage and the authority page are related to one another may comprise determining if a two way relationship exists between the first webpage and the authority page, wherein the two way relationship comprises identifying a record of the relationship between the authority page and the first webpage at the social networking site and at the website.

The endorsement count of the authority page may comprise the primary count of the authority page. The endorsement count of the authority page may comprise the sum of the primary count of the authority page and one or more other webpages related the authority page, wherein the one or more other webpages are identified as a canonical page of the authority page.

The operations may further include providing the secondary count for display at one or more of the first webpage and the authority page. The operations may further include receiving an indication of an endorsement at one of the first webpage and the authority page, incrementing a primary count of the one of the first webpage and the authority page in response to receiving the indication and incrementing a secondary count of the first webpage and the authority page in response to receiving the indication.

The operations may further include determining if the authority page is related to one or more other webpages, identifying the one or more other webpages related to the authority page, if it is determined that the authority page is related to the one or more other webpages and incrementing a secondary count of the one or more other webpages in response to receiving the indication.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example client-server network environment, which provides for facilitating smearing of endorsements among related webpages.

FIG. 2 illustrates a flow diagram of an example process for creating an association between a social networking page and an authority page at an external website for maintaining a total endorsement record across a family of pages.

FIG. 3 illustrates a flow diagram of an example process for maintaining a total number of endorsements across the entire family of pages, including webpages and/or page/profile(s) at a social networking service.

FIG. 4 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Various social networking services may allow an entity (profile owner) to create a social networking profile and/or page. The profile/page may represent a business or organization having a website. In such instances, the profile owner may associate a webpage at the website (e.g., a home page) belonging to the business with the page/profile. Social networking services may further provide a mechanism for allowing users of the service or other services or applications to endorse the website/webpage and/or social profile/page of the profile owner. For example, a button or other user input mechanism may be provided at the webpage(s) and/or profile/page at the social networking service, allowing the user to endorse the business.

The term “endorsement” as used herein may refer to an action taken by the user with respect to a web document (e.g., a social networking page/profile or a website/webpage) to indicate that the user has viewed and indicated an interest in and/or endorsed the page. Endorsement by the user may be shared with one or more other users associated with the user (e.g., contacts of the user). While the present disclosure describes various implementations with respect to endorsement, it should be understood that same or similar processes may be performed with respect to one or more other user activity (e.g., social activity such as comments, sharing, reviews, etc.) to provide similar advantages.

The endorsement mechanism may be annotated with a current click count that keeps track of the aggregate number of endorsements of the webpage or social networking service profile/page in which the endorsement mechanism is embedded. The present disclosure provides a method and system for reflecting the total number of clicks across the entire family of URLs sharing a canonical URL, including the page and/or profile of the profile owner at the social networking service. Furthermore, the present disclosure provides a method for maintaining a historical account of the endorsements and for providing the aggregate count as well as periodic reports of the increases in the endorsement count and segmented reports of endorsements for each URL in the family of URLs within the canonical family.

The system keeps track of all endorsements occurring at an authority page and each of one or more other URLs sharing a canonical URL with the authority page, including the social networking profile and/or page of a profile owner. For each of these URLs the system maintains a primary count which provides the click count for endorsements using the endorsement mechanism at that URL. In one example, the primary count of the authority page and/or one or more of the other URLs sharing a canonical URL with the authority page may further include the count for one or more canonical URLs of the authority page.

Furthermore, a secondary count is provided for each of the URLs. The secondary count is calculated by determining an association between the authority page, one or more canonical URLs and/or a social networking service profile/page. The association is determined by determining if a two way link exists between a social networking page and an authority page. Each entity owning a profile/page at the social networking service may associate that profile/page (e.g., identified by URL) with at least one authority page (e.g., a URL).

When the system receives an indication of an endorsement at a first page (e.g., a social networking profile/page or a webpage at an external website), the system determines if the page (e.g., identified by a URL) is associated with one or more other pages (e.g., one or more webpages or social networking profile/pages). The association may include an association between a canonical URL and a main page, or between an authority page and a social networking profile page. Once the association is determined, the endorsement is added to the secondary count for all associated pages. The endorsement is also added to the primary count of the page at which the endorsement was entered. In one example, a single primary count may be maintained for a main page and all its canonical pages. In such example, the endorsement increments the count for the main page and/or canonical pages, if the endorsement was entered at the main page or one of the canonical pages. The primary count allows modification of the secondary count if the association between two pages (e.g., a profile/page at a social networking service and an authority page) is later modified. For example, if the association is modified such that an authority page is disassociated with a first social networking page/profile and associated with a second social networking page/profile the secondary count for each entity is updated using the primary count of the authority page (and/or its one or more canonical URLs) and the social networking profile page.

Furthermore, the system supports maintaining a record (e.g., a look up table) of the association of each unique page of a family of pages, maintaining a record of endorsement for each unique page as well as metadata (e.g., the source of the endorsement, date of endorsement, etc.) for each endorsement. Thus, the system can provide information regarding both the aggregate count, as well as specific information regarding each unique page within a family of pages (e.g., the authority page, canonical pages, and the social networking page/profile).

Users of social networking services may create associations with one another. The phrase “social networking service” as used herein encompasses its plain and ordinary meaning, including, but not limited to, an online service, platform or site that focuses on building and reflecting of social associations among users. These associations may be stored within a social graph at each social networking service (e.g., maintained at remote server(s) 120). Such user associations may be defined on a user-to-user basis, or as a group of users associated through membership within a group. As used herein, “contacts” refer to other users that a user is associated with, at one or more social networking services.

Users of social networking sites may generate various content, referred to herein as “posts”. Posts may include various content shared at a social networking service, including but not limited to original content and/or existing content reshared at the social networking site. In one example, each user of a social networking service may be associated with a profile and/or page.

In one example, posts generated by the user may be posted to a social networking profile or page of the user. In one example, the user page/profile may be associated with an external website or webpage within a website (referred to as the “authority page”). One or more users may view content on the social networking profile/page and/or the external website (e.g., at the authority page or one or more canonical pages) and may endorse the content and/or the entire page(s) using various endorsement mechanisms.

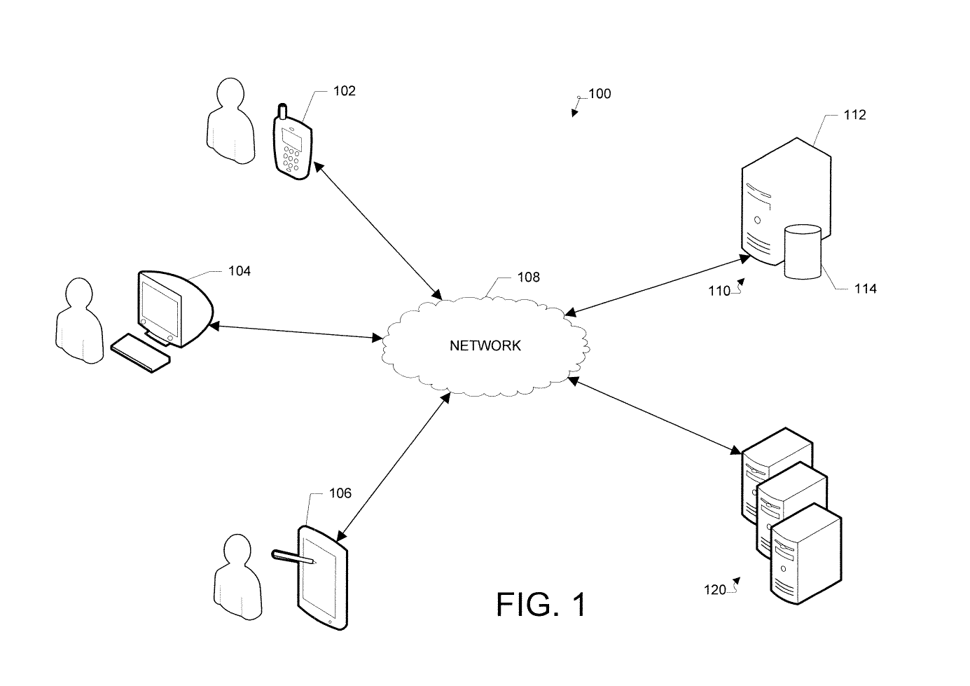

FIG. 1 illustrates an example client-server network environment, which provides for facilitating smearing of endorsements among related webpages. A network environment 100 includes a number of electronic devices 102, 104, 106 communicably connected to a server 110 and remote servers 120 by a network 108. Network 108 can be a public communication network (e.g., the Internet, cellular data network, dialup modems over a telephone network) or a private communications network (e.g., private LAN, leased lines). Further, network 108 can include, but is not limited to, any one or more of the following network topologies, including a bus network, a star network, a ring network, a mesh network, a star-bus network, a tree or hierarchical network, and the like.

In some example implementations, electronic devices 102, 104, 106 can be computing devices such as laptop or desktop computers, smartphones, PDAs, portable media players, tablet computers, or other appropriate computing devices. In the example of FIG. 1, electronic device 102 is depicted as a smartphone, electronic device 104 is depicted as a desktop computer and electronic device 106 is depicted as a PDA.

In some implementations, server 110 includes a processing device 112 and a data store 114. Processing device 112 executes computer instructions stored in data store 114, for example, to facilitate smearing of endorsements among related webpages associated with users interacting with electronic devices 102, 104, 106. Server 110 may further be in communication with remote servers 120 either through the network 108 or through another network or communication means.

According to some aspects, server 110 and/or remote servers 120 can be any system or device having a processor, a memory and communications capability for hosting various social networking services and/or external websites and webpages. Remote servers 120 may be further capable of maintaining social graphs of users and their contacts. The social networking services hosted on the server 110 and/or remote server(s) 120 may enable users to create a profile and associate themselves with other users at a remote social networking service. The remote servers 120 may further facilitate the generation and maintenance of a social graph including the user created associations. The social graphs may include, for example, a list of all users of the remote social networking service and their associations with other users of a remote social networking service. In some implementations, the server 110 and/or remote server(s) 120 may further maintain an association between a social networking profile/page and at least one external webpage and/or between an external webpage and one or more canonical pages.

In some example aspects, server 110 and/or one or more remote servers 120 can be a single computing device such as a computer server. In other implementations, server 110 and/or one or more remote servers 120 can represent more than one computing device working together to perform the actions of a server computer (e.g., cloud computing). Server 110 and/or one or more remote servers 120 may be coupled with various remote databases or storage services. While server 110 and the one or more remote servers 120 are displayed as being remote from one another, it should be understood that the functions performed by these servers may be performed within a single server, or across multiple servers.

Communications between the client devices 102, 104, 106, server 110 and/or one or more remote servers 120 may be facilitated through the HTTP communication protocol. Other communication protocols may also be facilitated including for example, XMPP communication, for some or all communications between the client devices 102, 104, 106, server 110 and one or more remote servers 120 (e.g., through network 108).

Users may interact with the system hosted by server 110, and/or one or more social networking services hosted by remote servers 120, through a client application installed at the electronic devices 102, 104, 106. Alternatively, the user may interact with the system and the one or more social networking services through a web based browser application at the electronic devices 102, 104, 106. Communication between client devices 102, 104, 106 and the system, and/or one or more social networking services, may be facilitated through a network (e.g., network 108).

The network 108 can include, for example, any one or more of a personal area network (PAN), a local area network (LAN), a campus area network (CAN), a metropolitan area network (MAN), a wide area network (WAN), a broadband network (BBN), the Internet, and the like. Further, the network 108 can include, but is not limited to, any one or more of the following network topologies, including a bus network, a star network, a ring network, a mesh network, a star-bus network, tree or hierarchical network, and the like.

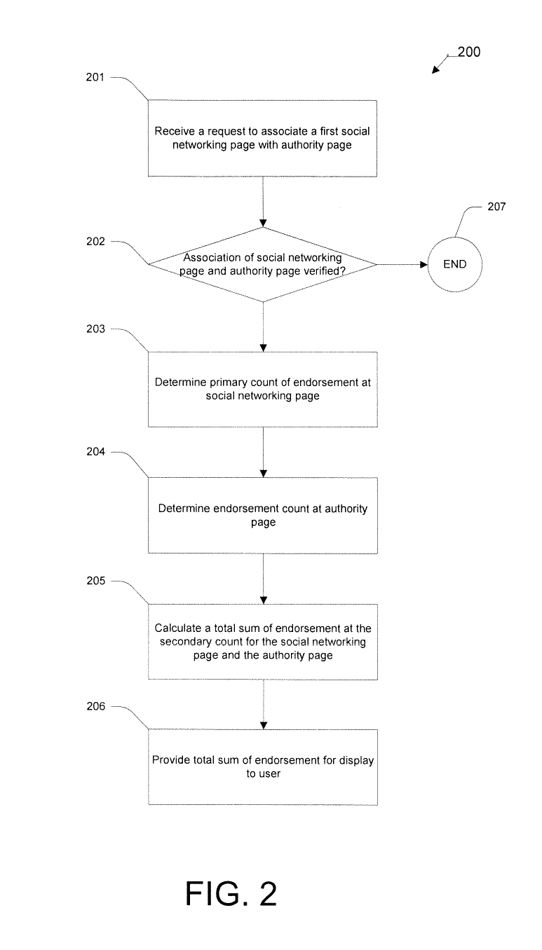

FIG. 2 illustrates a flow diagram of an example process 200 for creating an association between a social networking page and an authority page at an external website for maintaining a total endorsement record across a family of pages. In step 201, a request is received to associate a first social networking page with an authority page. In one example, the authority page is an external webpage/website, for example, identified by a URL. Each authority page may further be associated with one or more related canonical pages, and/or may be a canonical page of another website/webpage. In such example, once the user associates the social networking profile/page and the external authority page, the social networking site may further be related to the one or more additional webpages.

In step 202, a determination is made as to whether the association of the social networking page and authority page is verified. In one example, the verification is performed by determining if a two way link exists between the social networking page and the authority page. Each entity owning a profile/page at the social networking service may associate that profile/page with an authority page (e.g., a URL). The association may include indicating at the authority page that the page is related to a social networking page and further indicating an association of the social networking page with the authority page at the social networking service. In such instances, the relationship between the authority page and the social networking page is verified by determining if both the social networking page and the authority page have indicated a link to one another.

If, in step 202, the association between the social networking page and the webpage is not verified, the process terminates in step 207. Otherwise, after the association between the social networking page and the authority page is verified, the process continues to step 203. In step 203, a primary count associated with the social networking page is determined. As described above, various endorsement mechanisms (e.g., a button) may be provided for allowing users of the service or other services or applications to endorse content and/or pages at the social networking site as well as content/pages at external websites. For each entity having an endorsement mechanism, a primary count providing the click count for endorsements at the entity (e.g., social networking page or webpage) using the endorsement mechanism may be provided.

In step 204, an endorsement count associated with the authority page is determined. In one example, the endorsement count of the authority page comprises the primary endorsement count at the authority page. In one example, the endorsement count of the authority page is the click count for endorsements at the webpage (e.g., associated with the specific URL). In another example, the endorsement count of the authority page may further include the click count for endorsements at one or more canonical URLs of the authority page. As described above, the authority page may be a primary page associated with one or more other canonical URLs and/or may be a canonical page of another authority page. In some implementations, the endorsement count of the authority page and/or one or more other external pages associated with the authority page. In some implementations, during step 204, in addition to determining an endorsement count (e.g., primary count) for the authority page, an endorsement count (e.g., primary count) associated with one or more other webpages associated with the authority page (e.g., canonical pages) may also be determined.

In step 205, the system generates a total sum of endorsement for the social networking page and the authority page. The total sum may is the sum of the primary count of the social networking page, and a sum of endorsement at the one or more external pages. In one example the sum of endorsements is the endorsement count determined in step 204. In another example, the sum of primary endorsements of the authority page and/or any other external pages identified as being associated with the authority page (e.g., one or more canonical pages). The total sum is stored as a secondary count associated with the social networking page and the authority page. In one example, the total sum is further stored as the secondary count for on or more other external pages associated with the authority page (e.g., one or more canonical pages). In one example, when an endorsement count associated with a page is displayed (e.g., to one or more users viewing the page) the secondary count may be displayed reflecting the total number of clicks across the entire family of URLs sharing a canonical URL, including the page and/or profile of the profile owner at the social networking service.

Once the social networking page and the authority page are associated, the system will continue to update the secondary count for the social networking page, the authority page and/or one or more other pages (e.g., external webpages associated with the authority page as a canonical page).

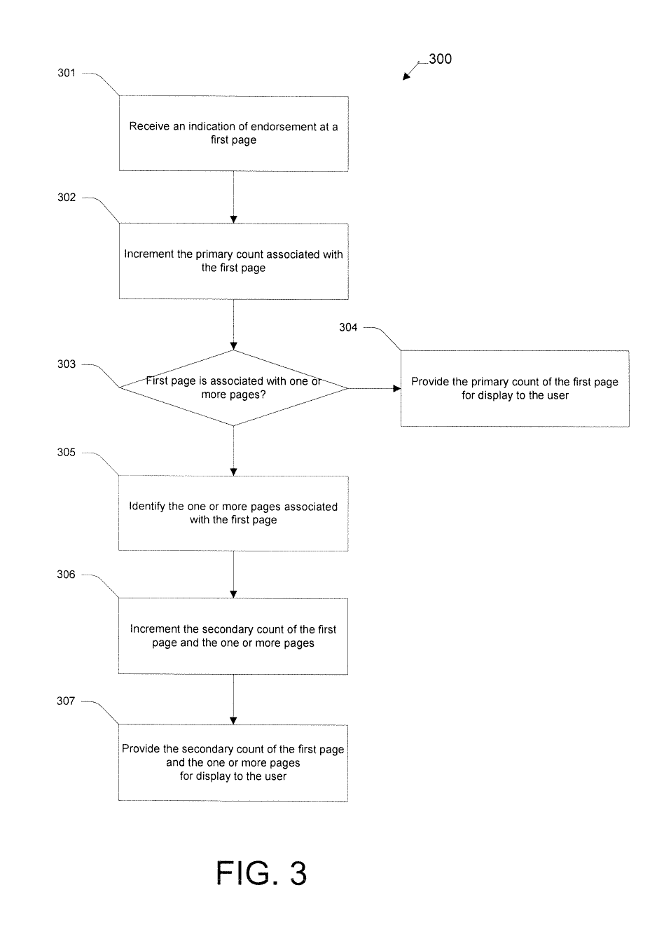

FIG. 3 illustrates a flow diagram of an example process 300 for maintaining a total number of endorsements across the entire family of pages, including webpages and/or page/profile(s) at a social networking service. In step 301, an indication of an endorsement at a first page (e.g., a page at a social networking service or an external webpage) is received. In step 302, the primary count associated with the first page is incremented in response to the indication. The primary count for a page provides the click count for endorsements using the endorsement mechanism at that page (e.g., identified by a URL). In one example, the primary count of the first page may further include the count for the one or more canonical pages where the first page is an external webpage associated with one or more canonical pages.

In step 303, it is determined if the first page is associated with one or more other pages. If, in step 303, it is determined that the first page is not associated with any other pages (e.g., one or more webpages and/or social networking page/profiles) the process continues to step 304. In one example a first page is associated with one or more other webpage if the first webpage and the one or more other pages are within the same family and thus related to one another. In step 304, the primary count of the first page is provided for display to the user. Otherwise, in step 305, the one or more pages associated with the first page are identified. In one example, the first page is a social networking page associated with an authority page (e.g., an external webpage/website). In such a case, in addition to the webpage directly associated with the social networking site page/profile, the system may also identify one or more webpages associated with the authority page (e.g., one or more canonical URLS). In another example, the first page is a webpage associated with one or more webpages/websites (e.g., canonical URLs) and/or with a social networking page.

In step 306, a secondary count of the first page and the identified one or more pages are incremented. In step 307, the secondary page is provided for display at the first page and the one or more pages associated with the first page, indicating the sum of endorsements for a page (e.g., a webpage or social networking page) and one or more pages associated with the page (e.g., one or more webpages and/or social networking pages).

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

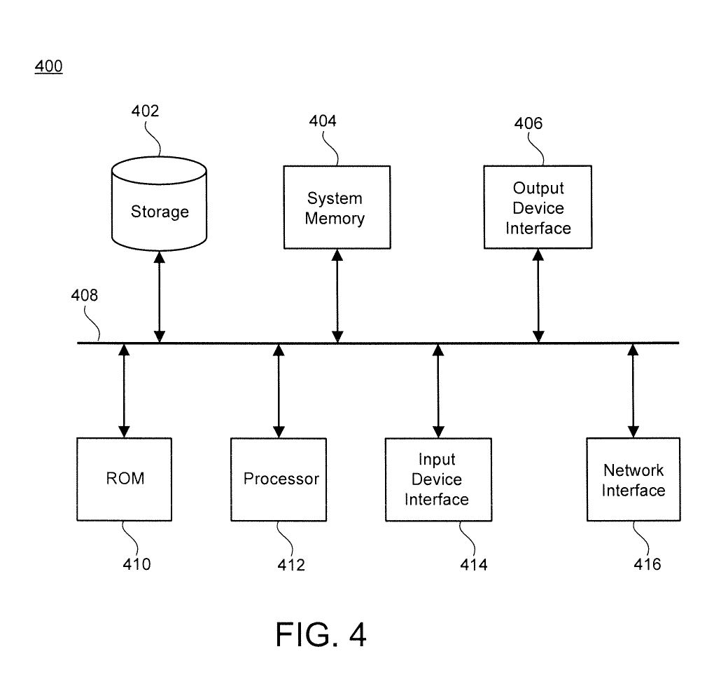

FIG. 4 conceptually illustrates an electronic system with which some implementations of the subject technology are implemented. Electronic system 400 can be a server, computer, phone, PDA, laptop, tablet computer, television with one or more processors embedded therein or coupled thereto, or any other sort of electronic device. Such an electronic system includes various types of computer readable media and interfaces for various other types of computer readable media. Electronic system 400 includes a bus 408, processing unit(s) 412, a system memory 404, a read-only memory (ROM) 410, a permanent storage device 402, an input device interface 414, an output device interface 406, and a network interface 416.

Bus 408 collectively represents all system, peripheral, and chipset buses that communicatively connect the numerous internal devices of electronic system 400. For instance, bus 408 communicatively connects processing unit(s) 412 with ROM 410, system memory 404, and permanent storage device 402.

From these various memory units, processing unit(s) 412 retrieves instructions to execute and data to process in order to execute the processes of the subject disclosure. The processing unit(s) can be a single processor or a multi-core processor in different implementations.

ROM 410 stores static data and instructions that are needed by processing unit(s) 412 and other modules of the electronic system. Permanent storage device 402, on the other hand, is a read-and-write memory device. This device is a non-volatile memory unit that stores instructions and data even when electronic system 400 is off. Some implementations of the subject disclosure use a mass-storage device (such as a magnetic or optical disk and its corresponding disk drive) as permanent storage device 402.

Other implementations use a removable storage device (such as a floppy disk, flash drive, and its corresponding disk drive) as permanent storage device 402. Like permanent storage device 402, system memory 404 is a read-and-write memory device. However, unlike storage device 402, system memory 404 is a volatile read-and-write memory, such a random access memory. System memory 404 stores some of the instructions and data that the processor needs at runtime. In some implementations, the processes of the subject disclosure are stored in system memory 404, permanent storage device 402, and/or ROM 410. For example, the various memory units include instructions for smearing of endorsements among related webpages according to various embodiments. From these various memory units, processing unit(s) 412 retrieves instructions to execute and data to process in order to execute the processes of some implementations.

Bus 408 also connects to input and output device interfaces 414 and 406. Input device interface 414 enables the user to communicate information and select commands to the electronic system. Input devices used with input device interface 414 include, for example, alphanumeric keyboards and pointing devices (also called “cursor control devices”). Output device interfaces 406 enables, for example, the display of images generated by the electronic system 400. Output devices used with output device interface 406 include, for example, printers and display devices, such as cathode ray tubes (CRT) or liquid crystal displays (LCD). Some implementations include devices such as a touchscreen that functions as both input and output devices.

Finally, as shown in FIG. 4, bus 408 also couples electronic system 400 to a network (not shown) through a network interface 416. In this manner, the computer can be a part of a network of computers (such as a local area network (“LAN”), a wide area network (“WAN”), or an Intranet, or a network of networks, such as the Internet. Any or all components of electronic system 400 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that some illustrated steps may not be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A computer-implemented method for combining endorsements in related webpages, the method comprising:
receiving, at one or more computing devices, a first indication of a first endorsement at a first webpage, the first webpage being a profile or page at a social networking site, the first webpage being associated with a first endorsement count of user endorsements for the first webpage;
incrementing, using the one or more computing devices, the first endorsement count in response to receiving the first indication;
determining, using the one or more computing devices, that the first webpage is related to a canonical webpage outside the social networking site when a two-way relationship exists between the first webpage and the canonical webpage, wherein a plurality of addresses resolve to a same base canonical address of the canonical webpage;
determining, based on determining that the first webpage is related to the canonical webpage, a respective count of user endorsements for each address of the plurality of addresses;
receiving a second indication of a second endorsement at the canonical webpage;
incrementing, using the one or more computing devices, based on receiving the second indication and when the two-way relationship exists, a second endorsement count of user endorsements for the canonical webpage and a total sum of the first endorsement count and a count of user endorsements for all of the plurality of addresses; and
providing, using the one or more computing devices, the first endorsement count and the total sum for display together at the first webpage.

2. A computer-implemented method for combining endorsements in related webpages, the method comprising:
receiving, at one or more computing devices, an indication of an endorsement at a first webpage, the first webpage being a profile or page at a social networking site;
determining, using the one or more computing devices, that a first address of the first webpage is related to an authority page when a two-way relationship exists between the first webpage and the authority page, a first address of the authority page being in a canonical relationship with one or more second addresses of the authority page such that the first address and the one or more second addresses resolve to a same base canonical address; and
determining, responsive to determining that the first webpage is related to the authority page, a respective count of endorsements for each of the first webpage, first address of the authority page, and each of the one or more second addresses;
incrementing, using the one or more computing devices in response to receiving the indication and when the two-way relationship exists, a first endorsement count of the first webpage and a second endorsement count based on a sum of the respective counts of endorsements; and
providing, using the one or more computing devices, the first endorsement count and the second endorsement count for display together at the first webpage.

3. (canceled)

4. The method of claim 2, wherein the second endorsement count is provided in response to a request to provide an endorsement count of one or more of the first webpage or the authority page.

5. The method of claim 2, wherein each profile or page of the social networking site is related to a webpage at a website, and wherein a webpage at a website is related to one or more other webpages at the website.

6. The method of claim 2, wherein the first webpage is remote and independent from the social networking site.

7. The method of claim 2, further comprising:
determining a third endorsement count for the authority page, wherein the second endorsement count comprises a sum of the third endorsement count and count of endorsements of a second webpage; and
assigning the second endorsement count to the first webpage, the authority page and the second webpage.

8. The method of claim 7, wherein the two-way relationship comprises the first webpage comprising a link to the authority page and vice versa.

9. (canceled)

10. (canceled)

11. The method of claim 2, wherein one or more other webpages are identified as a canonical page of the authority page.

12. The method of claim 2, further comprising:
storing, using the one or more computing devices, a record of endorsement of the first webpage with respect to the first webpage and the authority page, the record comprising an identity of the first webpage and an identity of an entity providing the endorsement.

13. The method of claim 12, further comprising:
receiving a request to provide historical information regarding the endorsement of one or more of the first webpage or one or more other webpages;
identifying one or more endorsements included within the second endorsement count;
determining information regarding each of the identified one or more endorsements; and
providing the information for display in response to the request.

14. A system for combining endorsements in related webpages, the system comprising:
one or more processors; and
a machine-readable medium comprising instructions stored therein, which when executed by the processors, cause the processors to perform operations comprising:
receiving a request to associate a first webpage associated with a social networking site with an authority page outside the social networking site, wherein a first address of the authority page is in a canonical relationship with one or more second addresses of the authority page such that the first address and the one or more second addresses resolve to a same base canonical address;
determining whether a two-way relationship exists between the first webpage and the authority page; and
if the two-way relationship exists between the first webpage and the authority page:
determining a first endorsement count of the first webpage, and a respective count of endorsements for each of the first address and the one or more second addresses of the authority page,
generating an endorsement total comprising a sum of the first endorsement count and respective counts of endorsements, and
providing the sum to be displayed together with the first endorsement count at the first webpage at the authority page.

15. The system of claim 14, wherein the two-way relationship comprises a record of the two-way relationship between the authority page and the first webpage being identified.

16. (canceled)

17. The system of claim 14, wherein the operations further comprise:
determining a second endorsement count for the authority page, wherein the second endorsement count comprises endorsements of the authority page and endorsements of one or more other webpages related the authority page, wherein each address of the one or more other webpages is in the canonical relationship with the one or more second addresses of the authority page.

18. (canceled)

19. The system of claim 14, the operations further comprising:
receiving an indication of an endorsement at one of the first webpage and the authority page;
incrementing the first endorsement count of the one of the first webpage and an endorsement count of the authority page in response to receiving the indication; and
incrementing the endorsement total in response to receiving the indication.

20. The system of claim 19, the operations further comprising:
determining if the authority page is related to one or more other webpages; and
incrementing an endorsement count of the one or more other webpages in response to receiving the indication.

21. The method of claim 1, wherein the first webpage is in a canonical relationship with the canonical webpage, and is associated with the same base canonical address.

22. The method of claim 2, wherein the first webpage is in a canonical relationship with the authority page, and is associated with the same base canonical address.

23. The system of claim 14, wherein the first webpage is in a canonical relationship with the authority page, and is associated with the same base canonical address.
